(19) United States
(12) Patent Application Publication
(10) Pub. No.: US 2005/0253347 A1
(43) Pub. Date: Nov. 17, 2005

(54) Snowboard binding

(75) Inventors: Peter Martin, Saaldorf-Surheim (DE); Jurg Kunz, Bilten (CH)

Correspondence Address: RANKIN, HILL, PORTER & CLARK LLP, 4080 ERIE STREET, WILLOUGHBY, OH, 44094-7836, US

(73) Assignee: DAKUGA HOLDING LTD, Bilten (CH)

(21) Appl. No.: 10/507,279

(22) PCT Filed: Mar. 13, 2003
(86) PCT No.: PCT/CH03/00169

§ 371 Date: Nov. 15, 2004

(30) Foreign Application Priority Data
Mar. 13, 2002 (CH) 430/02

(51) Int. Cl. B62B 17/00

(52) U.S. Cl. 280/14.22

(57) ABSTRACT

A snowboard binding (1) including a base plate (2) and a structure (3) for fastening a snowboard boot. The snowboard binding is provided with at least one load introducing structure(7, 8). The angle, arrangement, and direction of the at least one load introducing structure, in relation to the base plate, is adjustable in an essentially independent manner. The at least one load introducing structure (7, 8) transfers forces between a snowboard boot and a snowboard.

The invention relates to a binding for snowboards, according to the preamble of the independent patent claim.

Various bindings for snowboards are known from the state of the art, which change the flexion behaviour of a snowboard by way of leading to a localised stiffening. Since known bindings transmit forces very locally and centrally onto the snowboard, the snowboard is willingly mechanically overloaded in the region of the load introduction points. Furthermore, known bindings may only be adjusted (set) to the different styles of travel and requirements in quite an inadequate manner. A further disadvantage lies in the fact that when travelling curves, parts projecting beyond the snowboard tend to snag on the ground.

Conventional bindings offer no possibilities in order to dampen knocks and impacts, and these is are therefore transmitted directly onto the joints of the traveller, in particular on jumping.

Various spacer means are known which are independent of the type of binding and which are not integrated into a binding. These are designed in a manner such that they are arranged between a commercially available binding and a snowboard. A spacer means is known from the patent WO 00/32285 which in practise has very good properties on transmitting forces between the traveller and the snowboard. It effects an efficient damping of knocks and impacts, and this contributes to the running smoothness of the snowboard and to a certain extent reduces the influence of the binding on the flexion behaviour of the snowboard. A certain disadvantage however lies in the fact that the spacer means in combination with the binding is relatively heavy and therefore a certain influence of the binding on the flexion behaviour of the snowboard is unavoidable. Conventional binding systems, on account of the relatively large weight, have a negative influence on the inertia of the whole snowboard/binding system. The turning enthusiasm is negatively influenced by way of this.

It is the object of the invention to specify a snowboard binding which effects no negative changes on the flexion behaviour of the snowboard, and does not result in the disadvantageous increase in mass or inertia, but despite this efficiently dampens knocks and impacts.

The object is achieved by the snowboard binding defined by the patent claims.

The invention lies in a binding for snowboards which comprises one or more specifically arranged and adjustable load introduction means which are (inter)actively connected to a single-part or multi-part middle part which as a rule comprises the means for fastening a snowboard boot. The middle part and/or the load introduction means may be detachably connected to the snowboard. With the load introduction means it is the case of elements which serve for transmitting forces and which with regard to the angle, distance and alignment may be adjusted independently of the rest of the binding. The load introduction means as a rule are arranged between a snowboard boot and a snowboard and transmit and distribute forces onto the snowboard in a direct or indirect manner. By way of the distributed force introduction, one succeeds in partially stiffening the snowboard in a manner which is not disadvantageous and thus this retains its flexion properties. Despite this however, harmful impacts and vibrations are dampened.

A preferred embodiment of the snowboard binding according to the invention comprises a middle part which consists of a base plate and a fastening part about which two crescent-shaped load introduction means arranged adjustable to this in an essentially diametrical manner are arranged. The load introduction means are arranged in the region of the tip or the heel of the snowboard boot and are (inter)actively connected to the middle part which is arranged there between. The load introduction means and/or the middle part of the snowboard binding are preferably designed in an exchangeable (modular) manner, and in a manner such that they may be exchanged for differently designed load introduction means which are matched to certain demands and snowboards. These load introduction means for example differ in their geometric design (thickness, base surface, angle), material selection and damping properties. The connection between the middle part and the load introduction means is preferably designed such that no significant stiffening of the snowboard results in the assembled condition.

The load introduction means as a rule form an integral component of the snowboard binding. Apart from an optimised introduction of the load, amongst other things they serve for setting the distance between the snowboard boot and the snowboard. The lever ratios which are important for the force transmission during travel are set by way of this distance. The load introduction means are preferably manufactured of an elastic material which absorbs energy so that they dampen vibrations, knocks and impacts occurring during travelling and jumping. The components of the snowboard binding and the load introduction means are preferably manufactured of plastic by way of injection moulding. The load introduction means as a rule have a low intrinsic stiffness so that they do not lead to any significant influencing of the flexion behaviour.

The load introduction means and/or the other parts of the snowboard binding are preferably manufactured by way of injection moulding. Good results are obtained by way of two-component injection moulding, in that e.g. two (or more) materials with different material properties are combined with one another by way of peripheral moulding. The snowboard binding is set to meet the requirements by way of a targeted selection of materials.

With regard to the selection of material, there exits the possibility of either using materials which together form a rigid (fixed) connection, or using materials which do not assume a fixed connection, i.e. assume a positive fit connection. Materials such as polycarbonate, polyamide, polyurethane, rubber and elastomeric materials are preferably combined with one another. A preferred embodiment contains two materials of which the first material has a material hardness which lies below 60 to 70 Shore and the second material has a material hardness which lies above 60 to 70 Shore.

By way of a combination of a relatively elastic material with a comparatively inelastic material, one succeeds in absorbing impacts and vibrations in an efficient manner. One embodiment comprises a load introduction means which is mainly manufactured of a comparatively inelastic first material and comprises at least one region of a comparatively elastic second material which is completely or partly surrounded or penetrated by this first material (an inverse design is also possible if required). The region of the comparatively inelastic first material at the same time serves mainly for transmitting, distributing and introducing the forces into (inter)actively connected means such as snowboard and snowboard boot, etc. The at least one region of the second, comparatively elastic material serves for damping and absorbing the impacts and vibrations and for influencing the stiffness behaviour of the region of the first material.

A preferred embodiment form comprises an essentially crescent-shaped or kidney-shaped load introduction means which comprises a region of a comparatively stiff first material which in the assembled condition lies on the surface of a snowboard over a surface or along an edge. This first region comprises a second region of a comparatively elastic, second material which is connected with a positive fit or with a material fit to the first material. Instead of an undetachable connection as typically results from two-component injection moulding, the individual regions may also be (inter)actively connected also by way of a detachable or undetachable snap connection or bonding (adhesive) connection. In this case, the individual regions are preferably manufactured as separate parts which may be connected to one another. In this manner the possibility exists of designing the load introduction means in a bridge-like manner with one or more contact regions (interaction regions). This load introduction means is preferably designed of several parts in that e.g. a main carrier element supported via support elements lies on the snowboard. The support elements at the same time are fixedly or detachably connected to the main carrier element and are manufactured of a comparatively elastic material. The main carrier element serves for the direct or indirect distribution and introduction of the forces into the snowboard boot and/or the snowboard. The load introduction means if required are arranged such that they may be adjusted in angle, alignment and distance with respect to the base plate or the edge of the snowboard. The inclination and the lever arm may be adjusted by way of differently high load introduction means.

The invention is explained in more detail by way of the embodiments shown in the figures. Schematically and in a greatly simplified manner there are shown in:

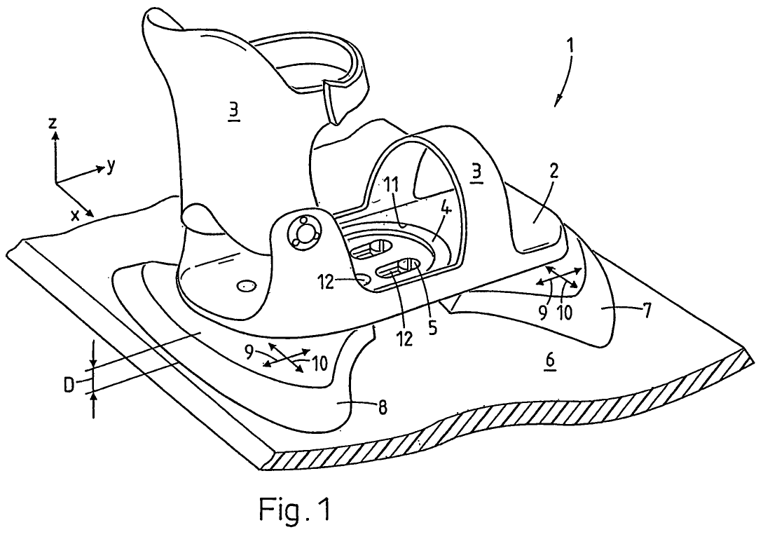

FIG. 1 a first embodiment of the snowboard binding;

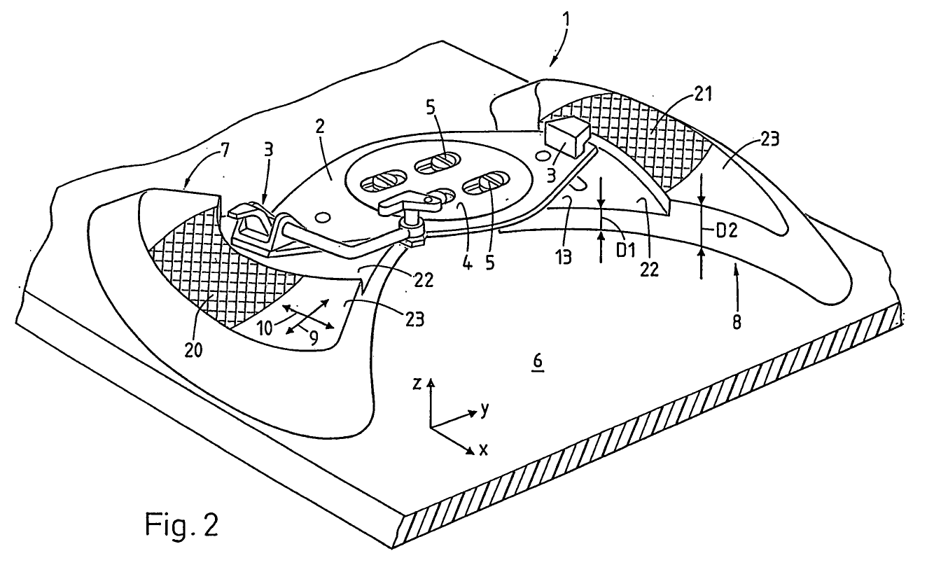

FIG. 2 a second embodiment of a snowboard binding;

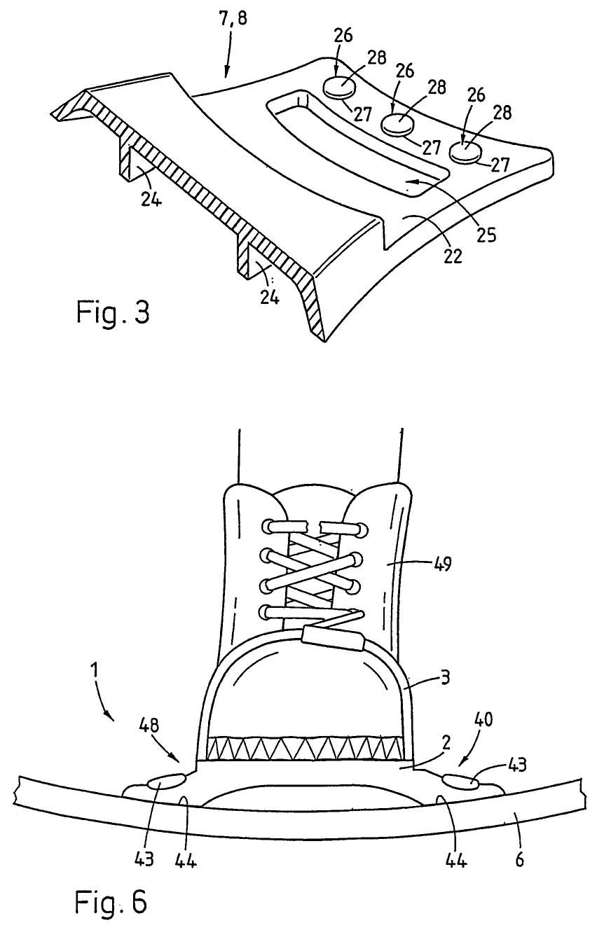

FIG. 3 a first load introduction means;

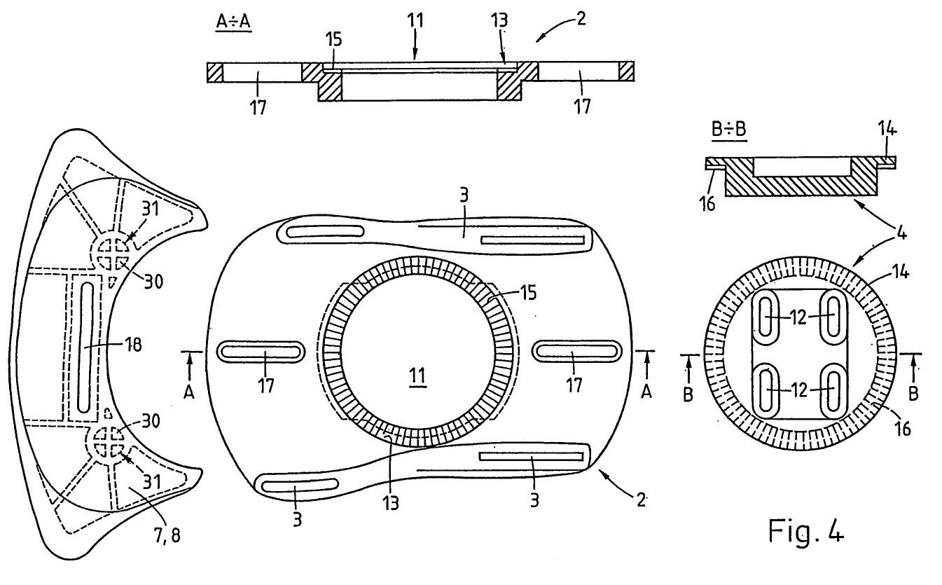

FIG. 4 various individual parts of a further embodiment form;

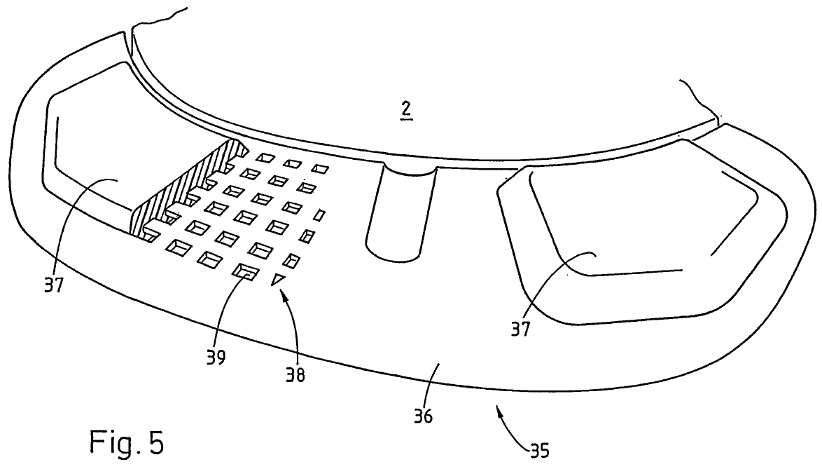

FIG. 5 a second load introduction means;

FIG. 6 a third embodiment of a snowboard binding.

FIG. 1 shows a first embodiment of a snowboard binding 1 according to the invention, in a perspective representation. The shown embodiment is particularly suitable for application with softboots (not shown in more detail), as are known from the state of the art

The snowboard binding 1 comprises a base plate 2 which contains the retaining means 3 for a snowboard boot (softboot, not shown in more detail) or is connected to this. The base plate 2 is connected to a snowboard 6, of which only one cut-out is shown, by way of a centrically arranged fastening element 4 and fastening means (screws) 5. Two load introduction means 7, 8 are arranged between the base plate 2 and the snowboard 6. The two load introduction means 7, 8 here are designed as crescent-like elements which lie on the snowboard 6 over their whole base surface. The load introduction means 7, 8 are arranged along the edge of the snowboard 6. They comprise a thickness D which essentially determines the distance between the base plate 2 and the snowboard 6. Different thicknesses D are e.g. compensated by way of screws 5 with an adapted length. The load introduction means 7, 8 represent a non-positive fit connection between the base plate 2 and the snowboard 6 in a manner such that forces, in particular compressive forces, are transmitted over a large area. With the shown embodiment, the vertical compressive forces are primarily transmitted in the region of the tip of the boot, and in the region of the heel of the snowboard boot indirectly via the base plate 2. A direct force transmission is possible with a suitable design, e.g. with suitably arranged cut-outs in the base plate.

The load introduction means 7, 8 in their arrangement, in particular in the radial and tangential direction may be adjusted largely independently of the base plate 2 and retaining means 3. By way of this, the snowboard binding 1 may be set to the width of the snowboard 6 and the alignment of the snowboard binding 1 with respect to the snowboard 6 may be adjusted in a targeted manner, and the forces may be introduced at defined locations. The load introduction means 7, 8 of the shown embodiment are preferably designed in an exchangeable manner. They have a modular construction which ensures the exchangeability.

The fastening of the load introduction means 7, 8 with the shown embodiment is either effected by way of suspension on the base plate 2 and/or on the fastening plate 4 serving as a fastening means. By way of tightening the screws 5, one succeeds in clamping the load introduction means 7, 8 between the base plate 2 and/or on the fastening plate 4 and the snowboard 6. Other fastening possibilities for example by way of separate fastening means are possible.

The base plate 2 in the middle comprises an opening 11 in which the correspondingly formed fastening means 4 is arranged. The edge of the opening 11 comprises a toothing (not shown in more detail) which corresponds with a correspondingly designed toothing (not shown in more detail) on the fastening plate 4 in a manner such that the snowboard binding 1 is secured against an undesired rotation about the height axis (z-axis) when the screws 5 are tightened. When the screws 5 are released however, an adjustment of the snowboard binding about the z-axis is possible. The fastening plate 4 comprises holes 12 which correspond to a plurality of hole patterns of snowboards which are obtainable on the market. The holes 12 in the shown embodiment have an elongate shape in a manner such that the position of the snowboard binding 1 in the transverse direction (y-axis) may be set with respect to the snowboard 6.

The load introduction means 7, 8 with the shown embodiment have an outline which is relatively wide towards the side edges of the snowboard 6 and tapers towards the middle of the snowboard 6. This design has the effect that the forces introduced by the traveller via the snowboard boot (not shown in more detail) are transmitted via the base plate 2 to the load introduction means 7, 8 and are transmitted by these onto the snowboard 2 over a large area. The parts of the snowboard binding 1 lying on the snowboard 6 may be designed such that they only lie discretely at certain locations and here introduce the loads in a targeted manner. Discrete contact regions are achieved in that e.g. reliefs are provided or doublings are deposited. The doublings may additionally comprise resilient (spring) or damping properties. The load introduction means may also be designed in the manner of an arc so that they have a targeted spring effect only at discrete locations.

By way of the described measures, one succeeds in not negatively influencing the flexibility of the snowboard in contrast to the bindings known from the state of the art. By way of a targeted decoupling, the natural “flex”-effect (intrinsic stiffness) of the snowboard is not disadvantageously influenced.

FIG. 2 shows a further embodiment of the invention. The snowboard binding 1 shown in this figure contains a base plate 2 with retaining means 3 for a snowboard boot (not shown in more detail). The retaining means 3 shown here are suitable for use with snowboard boots of the “step-in” system, as are known from the state of the art.

The snowboard binding 1 comprises two load introduction means 7, 8 which are arranged laterally of the base plate 2. The load introduction means 7, 8 are designed in a manner such that a region between the base plate 2 and the snowboard 6 is clamped in as soon as the screws 5 are tightened. The load introduction means 7, 8 comprise standing surfaces 20, 21 which are arranged in the region of the tip and of the heel of a snowboard (not shown in more detail) in a manner such that the forces between the snowboard boot and the snowboard 6 are transmitted in a direct manner. The base plate 2 in the middle comprises a recess 13 in which a fastening plate 4 is admitted. The fastening plate 4 in the region in which it lies on the base plate 2 comprises a toothing (means) which corresponds with a corresponding designed toothing (counter-means) of the base plate 2. The toothings mesh into one another and by way of this, when the fastening means 5 have been tightened, prevent an undesired displacement of the base plate 2 with respect to the snowboard 6 in the assembled condition.

The load introduction means 7, 8 comprise a first region 22 with a thickness D1 and a second region 23 with a thickness D2. The thickness D1 of the first region 22 determines the distance between the base plate 2 and the snowboard 6. The thickness D2 of the second region 23 determines the distance between the standing surfaces 20, 21 and the snowboard 6. The size of the lever arm which is important for the force transmission is determined by these thicknesses D1 and D2 of the first and of the second region 22, 23. The distance between the binding and the snowboard or the snowboard boot and the snowboard, in particular when travelling curves when the snowboard is set on a lateral edge, is of great significance.

The base plate 2 if required may be designed completely or partly elastically in a manner such that together with suitably designed load introduction means 7, 8 or doublings, it assumes a spring/damping function. The shape (base surface, thickness, angle) of the load introduction means 7, 8 may also differ from the design shown here, depending on the field of application.

Special single-part or multi-part arrangements are possible. Harmful knocks, impacts and vibrations are largely filtered out Additional, integrated or separate spring/damping elements, e.g. of elastic, foamed materials or in the form of gas-filled elements or chambers as are known from sports shoe technology may be combined with one another. Elements with changeable properties, e.g. by way of pumping or bleeding gas via a valve are likewise suitable.

With the shown embodiment, the load introduction means 7, 8 may be designed in a manner such that a cavity is formed between the snowboard 6 and the standing surface 20. This cavity may serve for accommodating spring/damping elements of the above mentioned type. A corresponding device may also be provided below the binding plate. Corresponding means of course may also be integrated into the other shown embodiments.

Instead of the retaining means 3 for a snowboard boot which are shown in the FIGS. 1 and 2, other retaining means are possible, in particular those as are known for hardboots from the state of the art. Alternatively retaining means which act laterally on a snowboard boot are also conceivable.

FIG. 3 shows a section through the load introduction means 7, 8 in a perspective representation. The shown load introduction means 7, 8 is manufactured of plastic As one may recognise, in the lower region it comprises reinforcement ribs 24. The load introduction means 7,8 if required may consist of a material which is suitable in order to damp knocks, impacts and vibrations. By way of this, on the one hand the joints of the traveller are spared, and on the other hand this has a positive effect on the running smoothness of the snowboard. The thickness of the first and/or second region 22, 23 may be set by way of additional distancing means (not shown in more detail). These distancing means are for example bonded (glued) on the standing surfaces 20, 21. With regard to the distancing means, it is the case for example of elements of soft rubber, hard foam or other soft or hard, damping or non-damping materials.

The shown load introduction means 7, 9 in the first region 22 which is clamped between the snowboard and the base plate 2 comprises a limitation means 25 for limiting the adjustable position. With these limitation means 25 it is a case of an opening 25 into which a counter means engages, which is arranged on the base plate 2 or the snowboard 6. Here, with regard to these counter means, it is the case of a peg (not shown in more detail) which engages into the opening 25 and in the assembled condition prevents the load introduction means 7,8 from slipping out below the base plate 2. The peg and the opening 25 furthermore limit the maximum adjustability of the load introduction means 7, 8 with respect to the base plate 2 or the snowboard 6.

The load introduction means 7, 8 comprises fixation means 26. With regard to these fixation means 26 it is the case for example of openings 27 into which pegs 28 of a material with a high coefficient of friction are admitted. These pegs 28 are mounted in an elastic manner or consist of elastic material and in the non-assembled condition project slightly beyond the edge of the opening 27. In the assembled condition, the load introduction means 7, 8 are clamped in between the base plate 2 and the snowboard 6 (cf. FIG. 2). The pegs 28 are pressed together by way of this. This has the result that the load introduction means may be locked in a flexible manner with respect to the base plate 2 and the snowboard 6. The pegs 28 may furthermore be designed in a manner such that they may assume a damping function of the base plate with respect to the snowboard 6. Other locking possibilities of the load introductions means 7 with respect to the base plate 2 and the snowboard 6 are possible.

FIG. 4 shows individual parts of a snowboard binding 1 similar to the snowboard binding 1 according to FIG. 1, said parts lying next to one another.

In the left half of the picture one may recognise one of two identical load introduction means 7, 8 in a plan view. A base plate 2 is shown in a plan view. A section AA through the base plate 2 is shown, seen from the observer above the plan view of the base plate 2. Retaining means 3 for a snowboard boot are only to be recognised in an indicated manner (cf. FIG. 1). The base plate 2 in the middle region comprises an opening 11 with a shoulder 13 and a first toothing 15. Two first elongate openings 17 are arranged laterally of the opening 11.

A fastening plate 4 may be recognised to the right of the base plate 2. This fastening plate 4 in the assembled condition of the snowboard binding is arranged in the opening 11 and serves for locking the base plate 2 on a snowboard. The fastening plate 4 comprises holes 12 which match with a plurality of hole patterns of snowboards obtainable on the market. One may alternatively apply different fastening plates which in each case have only one particular hole pattern for a snowboard.

The fastening plate 4 comprises a laterally projecting edge 14 with a second toothing 16. This second toothing 16 in the assembled condition engages into the first toothing 15 of the shoulder 13 of the base plate 2 from above in a manner such that the base plate 2 is locked with respect to the snowboard (not shown in more detail). By way of the meshing toothings, the base plate 2 may be locked at practically any angle with respect to the fastening plate.

The load introduction means 7, 8 of which only one is illustrated here, in each case comprise a second elongate opening 18. In the assembled condition, fixation screws (not shown in more detail) are arranged through these first and second elongate openings 17, 18 which serve for fixation of the load introduction means 7, 8 with respect to the base plate 2. The corresponding elongate first and second openings 17, 18 in the shown representation are arranged at a 90° angle to one another. By way of this one succeeds in being able to adjust the load introduction means 7, 8 with respect to the fastening plate 4, in angle, alignment and width, in a largely independent manner. The load introduction means 7, 8 on the lower side which faces the surface of the snowboard in the assembled condition comprise elements of slip-proof, elastic (for example soft-rubber or cellular rubber, etc). These elements 30 are arranged in recesses 31 and slightly project beyond these. In the assembled condition, these elements are pressed against the surfaces of the snowboard and by way of this prevent an undesired displacement of the load introduction means 7, 8. The load introduction means 7, 8 consist preferably of plastic and are manufactured by way of injection moulding. They may be manufactured of one or of several materials depending on the field of application. The load introduction means 7, 8 may have a layered construction. Their height may be changed for example by way of bonding (gluing) on additional elements. Depending on the construction of the load introduction means, these serve as a damping element for damping impacts and knocks and vibrations occurring in the snowboard which occur during travel.

FIG. 5 shows a load introduction means 35 which comprises a first and two second regions 36, 37 of different materials. The first region 36 consists of a comparatively inelastic material, and the two second regions 37, of which one is sectioned, of a comparatively elastic material. The two second regions 37 serve as interaction means for introducing and accommodating forces and loads with a binding plate (cf. FIG. 1) and/or a snowboard boot (cf. FIG. 6).

The two regions 36, 37 here are connected to one another by way of a positive fit in that the material of the second region 37 is arranged around an essentially grid-like formation 38 with grid openings 39, or encompasses these. By way of such a design which has a spatial penetration of the individual regions 36, 37, and by way of the material selection, one succeeds in efficiently absorbing vibrations, knocks and impacts. Specific properties are achieved by way of combining materials with a different density.

The first region 36 has a shell-like design which defines the mechanical properties, in particular stability and deformability. The embodiment of the load introduction means 35 shown here is preferably manufactured by way of two-component injection moulding. Alternatively or to supplement this, other connection forms such as bonding (gluing) or e.g. detachable or undetachable snap connections are possible. The load introduction means 35 is (inter)actively connected to a base plate 2 of a binding (cf. FIG. 1). The load introduction means 35 may be set in angle and alignment, preferably radially and tangentially, with respect to the base plate 2 and a snowboard (cf. FIG. 1).

FIG. 6 shows a further embodiment of a snowboard binding 1 with a snowboard boot 39 which is fastened on the snowboard binding 1 by way of retaining means 3. A snowboard 6 is represented in the flexed condition such as occurs during travel. The lower region 38 of the snowboard binding 1 or the at least one load introduction means 40 are designed such that it effects a compensating, neutralising effect between a comparatively stiff base plate 2 or the snowboard boot 39, and the elastic snowboard 6. The load introduction means 40 here comprises two elements 43 which consist of a vibration-damping material. The load introduction means 40 here is (inter)actively connected to the snowboard 6 via two flatly formed main interaction regions 44. Other designs which in particular are formed of one piece may be meaningful, depending on the desired property. Interaction regions which in a flat manner or along an edge zone of a component are circular, polygonal, straight, grid-like, and crescent-shaped or kidney-shaped are suitable. The interaction regions 44 preferably have a certain distance to the centre of the snowboard binding 1, i.e. to the screw connections 5 (cf. FIG. 1). They are preferably arranged peripherally, preferably in the edge region of the snowboard 6 so that a large lever arm and thus an efficient force transmission between the fastening means 5 and the interaction means 44 results.

In contrast to the state of the art, the snowboard binding 1 is designed such that it permits a compensation between different stiffnesses or bending behaviours of the snowboard 6 and the upper binding region 2, so that the properties of the snowboard, in particular its flexibility is not influenced locally in a lasting manner. The load introduction means 40 when required may be integrated into the base plate 2. Under certain circumstances, this has the result that the radial and/or tangential adjustability with respect to the snowboard 6 or with respect to the snowboard boot 39 is less flexible.

Further solutions for the set object are to be deduced by the may skilled in the art by way of combination of the embodiments shown in the figures.

1. A snowboard binding (1) with a base plate (2), with a retaining means (3) for a snowboard boot, and with at least one load introduction means (7, 8) that serves for transmitting forces between the snowboard boot and a snowboard (6), and with a fastening means (4) that serves for the detachable fastening of the base plate (2) and the at least one load introduction means (7, 8) on the snowboard.

2. A snowboard binding (1) according to claim 1, wherein the at least one load introduction means (7, 8) may be set in angle and alignment with respect to the base plate (2).

3. A snowboard binding (1) according to claim 1, wherein the at least one load introduction means (7, 8) is arranged laterally of the base plate (2) and at least in regions between the snowboard (6) and the snowboard boot and serves for the direct or indirect transmission of forces between the snowboard boot and the snowboard (6).

4. A snowboard binding (1) according to claim 1, wherein the at least one load introduction means (7, 8) is arranged at least in regions between the base plate (2) and the snowboard (6).

5. A snowboard binding (1) according to claim 1, comprising two load introduction means (7, 8) which are arranged essentially diametrically opposite the base plate (2) and which are arranged in a region of a tip and a heel of the snowboard boot.

6. A snowboard binding (1) according to claim 1, wherein the at least one load introduction means (7, 8) has a shape selected from the group consisting crescent-shaped, round, and rectangular.

7. A snowboard binding (1) according to claim 1, wherein the at least one load introduction means (7,8), due to its shape or material selection, is designed so as to elastically dampen impacts, knocks or vibrations.

8. A snowboard binding (1) according to claim 1, wherein the at least one load introduction means (7,8) in regions is arranged between the base plate (2) and the snowboard (6).

9. A snowboard binding (1) according to claim 1, wherein the at least one load introduction means (7, 8) serves for adjusting distance between the snowboard (6) and the snowboard boot.

10. A snowboard binding (1) according to claim 1, wherein the at least one load introduction means (7,8) lies (contacts) in a large-area manner or only at discrete locations.

11. A snowboard binding (1) according to claim 1, wherein the snowboard binding (1) or the at least one load introduction means (7, 8, 22, 23, 35, 40) is designed such that it compensates between the different stiffnesses of a snowboard (6) and a base plate (2).
